(19) United States
(12) Patent Application Publication
(10) Pub. No.: US 2019/0077101 A1
(43) Pub. Date: Mar. 14, 2019

(54) SILICONE HYDROGEL COMPOSITION, OPHTHALMIC LENS, AND METHOD FOR MANUFACTURING THE SAME

(71) Applicant: HON HAI PRECISION INDUSTRY CO., LTD., New Taipei (TW)

(72) Inventor: HSIU-WEN CHIEN, New Taipei (TW)

(21) Appl. No.: 15/706,741

(22) Filed: Sep. 17, 2017

(30) Foreign Application Priority Data
Sep. 11, 2017 (TW) 106131086

(51) Int. Cl. B29D 11/00; G02B 1/04; C08G 77/388; C07F 9/09; C08L 83/08

(52) U.S. Cl. CPC B29D 11/00067; G02B 1/043; B29D 11/00038; B29K 2105/0061; C07F 9/092; C08L 83/08; C08G 77/388

(57) ABSTRACT

A silicone hydrogel composition for an ophthalmic lens comprises tetraethoxysilane, 3-(trimethoxysilyl) propyl methacrylate, 2-hydroxyethyl methacrylate, a zwitterionic compound, a cross-linking agent, and an initiator. The disclosure also provides the ophthalmic lens, and a method manufacturing for the ophthalmic lens.

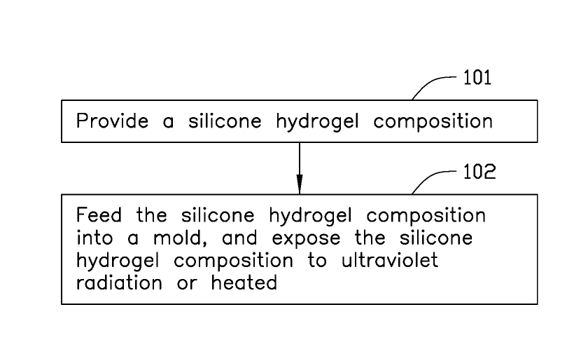

### FIELD

The subject matter herein generally relates to a silicone hydrogel composition, an ophthalmic lens, a method for manufacturing the ophthalmic lens.

### BACKGROUND

Contact lenses are commonly worn by users to correct vision, or for cosmetic or therapeutic reasons. Usually, bacteria are easy to adhere to surfaces of the contact lenses.

### BRIEF DESCRIPTION OF THE DRAWING

Implementations of the present disclosure will now be described, by way of example only, with reference to the attached figure, the figure being a flowchart of an embodiment of a method for manufacturing an ophthalmic lens according to the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

An exemplary embodiment of a silicone hydrogel composition comprises tetraethoxysilane, 3-(trimethoxysilyl) propyl methacrylate, 2-hydroxyethyl methacrylate, a zwitterionic compound, a cross-linking agent, and an initiator.

Tetraethoxysilane has a mass percentage of about 1% to about 25% of a total mass of the silicone hydrogel composition. 3-(trimethoxysilyl) propyl methacrylate has a mass percentage of about 0.5% to about 12% of a total mass of the silicone hydrogel composition. 2-hydroxyethyl methacrylate has a mass percentage of about 0 to about 76% of a total mass of the silicone hydrogel composition. The zwitterionic compound has a mass percentage of about 18% to about 97% of a total mass of the silicone hydrogel composition. The cross-linking agent has a mass percentage of about 0.32% to about 6.5% of a total mass of the silicone hydrogel composition. The initiator has a mass percentage of about 0.23% to about 5.8% of a total mass of the silicone hydrogel composition.

The zwitterionic compound can be selected from a group consisting of a sulfobetaine zwitterionic compound, a carboxybetaine zwitterionic compound, a phosphorylcholine zwitterionic compound, and any combination thereof. The sulfobetaine zwitterionic compound has a chemical structural formula of

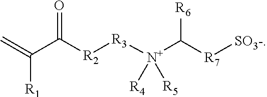

The carboxybetaine zwitterionic compound has a chemical structural formula of

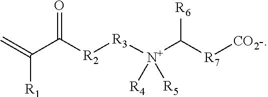

The phosphorylcholine zwitterionic compound has a chemical structural formula of

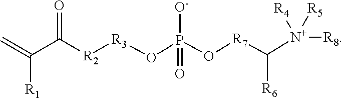

Wherein R₁ and R₆ each represents at least one of hydrogen group and methyl group. R₂ represents at least one of oxygen group and imino group. R₂ represents at least one of straight-chain alkane group, branched alkane group,

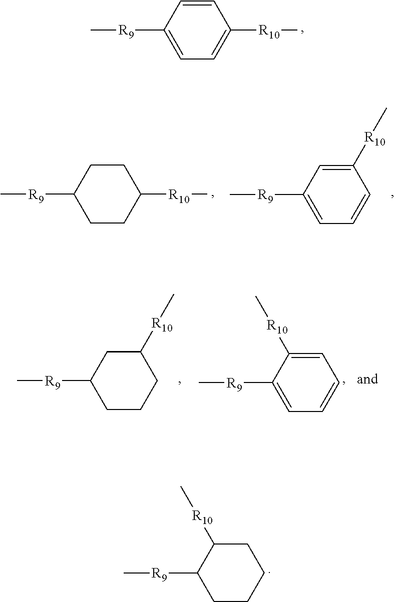

R₉ and R₁₀ each represents at least one of at least one of straight-chain alkane group and branched alkane group. R₄ and R₅ each represents at least one of methyl group, ethyl group, and propyl group. R₇ and R₈ each represents at least one of straight-chain alkane group and branched alkane group.

In at least exemplary embodiment, the zwitterionic compound is selected from a group consisting of [2-(methacryloyloxy) ethyl] dimethyl-(3-sulfopropyl) ammonium hydroxide having a chemical structural formula of

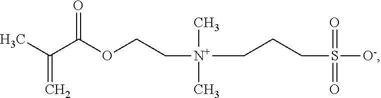

[3-(methacryloylamino) propyl] dimethyl(3-sulfopropyl) ammonium hydroxide inner salt having a chemical structural formula of

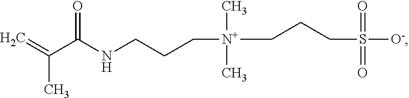

2-methacryloyloxyethyl phosphorylcholine having a chemical structural formula of

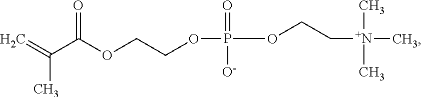 [SMILES: C=C(C)C(=O)OCCOP(=O)([O-])OCC[N+](C)(C)C]

[2-(methacryloyloxy) ethyl] dimethyl-(3-carboxypropyl) ammonium hydroxide having a chemical structural formula of

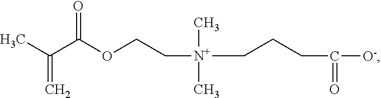

and any combination thereof.

The cross-linking agent may be selected from a group consisting of ethylene glycol dimethacrylate (EGDMA), trimethylolpropane trimethacrylate (TMPTMA), tri(ethylene glycol) dimethacrylate (TEGDMA), tri(ethylene glycol) divinyl ether (TEGDVE), trimethylene glycol dimethacrylate, and any combination thereof.

The initiator may be a photoinitiator or a thermal initiator.

The photoinitiator may be selected from a group consisting of benzoin methyl ether, diethoxyacetophenone, a benzoylphosphine oxide initiator, ethyl 2-dimethyl aminobenzoate, 2-isopropylthioxanthone, 1-hydroxycyclohexyl phenyl ketone, Darocur type initiator and Irgacur type initiator, and any combination thereof. In at least one exemplary embodiment, the photoinitiator may be Irgacure-1173. The benzoylphosphine oxide initiator may be selected from a group consisting of 2,4,6-trimethylbenzoyldiphenylophosphine oxide, bis-(2,6-dichlorobenzoyl)-4-N-propylphenylphosphine oxide, and bis-(2,6-dichlorobenzoyl)-4-N-butylphenylphosphine oxide, and any combination thereof.

The thermal initiator may be selected from a group consisting of 2,2′-azobis (2,4-dimethylpentanenitrile), 2,2′-azobis (2-methylpropanenitrile), 2,2′-azobis (2-methylbutanenitrile), azobisisobutyronite (AIBN), and peroxide, and any combination thereof. The peroxide can be benzoyl peroxide.

The figure illustrates a flowchart of a method for manufacturing an ophthalmic lens using the silicone hydrogel composition in accordance with an exemplary embodiment. The exemplary method is provided by way of example, as there are a variety of ways to carry out the method. Each block shown in the figure represents one or more processes, methods or subroutines, carried out in the exemplary method. Furthermore, the illustrated order of blocks is by example only and the order of the blocks can change. Additional blocks may be added or fewer blocks may be utilized, without departing from this disclosure. The exemplary method can begin at block 101.

At block 101, the silicone hydrogel composition is provided.

At block 102, the silicone hydrogel composition is fed into a mold and is exposed to ultraviolet radiation or heated, so tetraethoxysilane, 3-(trimethoxysilyl) propyl methacrylate, 2-hydroxyethyl methacrylate, the zwitterionic compound, the cross-linking agent, and the initiator in the silicone hydrogel composition undergo a polymerization reaction and form an ophthalmic lens.

The ophthalmic lens comprises

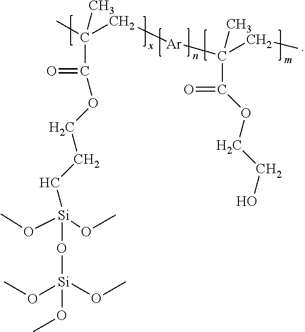

In at least one exemplary embodiment, a degree of polymerization x is from about 5 to about 45, a degree of polymerization n is from about 8 to about 72, and a degree of polymerization m is from about 13 to about 86

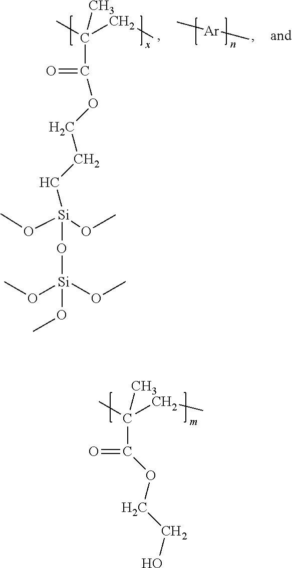

are alternatively bonded in that sequence.

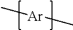

is selected from at least one of

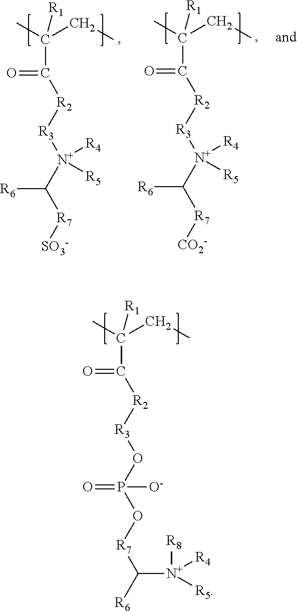

R₁ and R₆ each represents at least one of hydrogen group and methyl group. R₂ represents at least one of oxygen group and imino group. R₂ represents at least one of straight-chain alkane group, branched alkane group,

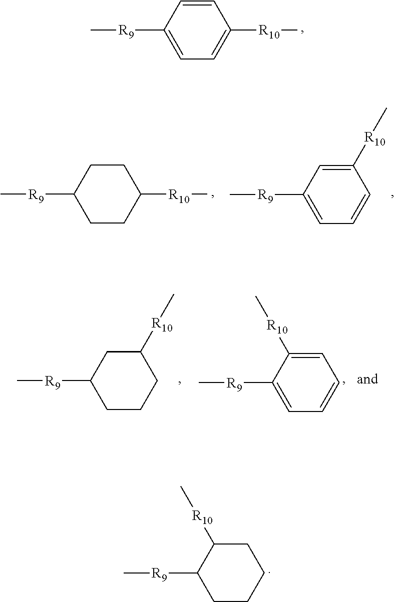

R₉ and R₁₀ each represents at least one of at least one of straight-chain alkane group and branched alkane group. R₄ and R₅ each represents at least one of methyl group, ethyl group, and propyl group. R₇ and R₈ each represents at least one of straight-chain alkane group and branched alkane group.

The ophthalmic lens comprises

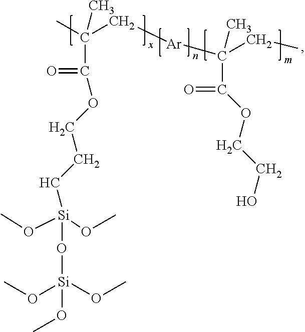

and Ar comes from zwitterionic compound, so that the ophthalmic lens has a good transparency, a good water-carrying capacity and a good oxygen permeability coefficient. Furthermore, the ophthalmic lens can prevent bacteria from adhering to a surface of the ophthalmic lens, thereby protecting eyes of a user.

In at least one exemplary embodiment, the mixture is exposed to ultraviolet radiation for about 5 min to about 30 min. The mixture is heated at about 65 degrees Celsius to about 90 degrees Celsius for about 45 min to about 6 h.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

### EXAMPLE 1

A silicone hydrogel composition is formed by mixing tetraethoxysilane, 3-(trimethoxysilyl) propyl methacrylate, 2-hydroxyethyl methacrylate, [2-(methacryloyloxy) ethyl] dimethyl-(3-carboxypropyl) ammonium hydroxide, ethylene glycol dimethacrylate, and Irgacure-1173. Tetraethoxysilane has a mass percentage of 5.36% of a total mass of the silicone hydrogel composition. 3-(trimethoxysilyl) propyl methacrylate has a mass percentage of 2.6% of a total mass of the silicone hydrogel composition. 2-hydroxyethyl methacrylate has a mass percentage of 29.4% of a total mass of the silicone hydrogel composition. [2-(methacryloyloxy) ethyl] dimethyl-(3-carboxypropyl) ammonium hydroxide has a mass percentage of 60.5% of a total mass of the silicone hydrogel composition. Ethylene glycol dimethacrylate has a mass percentage of 1.32% of a total mass of the silicone hydrogel composition. Irgacure-1173 has a mass percentage of 0.82% of a total mass of the silicone hydrogel composition. The silicone hydrogel composition is fed into a mold and is exposed to ultraviolet radiation for 12 min, thereby forming an ophthalmic lens. The ophthalmic lens has a transparency of about 97%, a water-carrying capacity of about 72%, and an oxygen permeability coefficient of about 80.

### EXAMPLE 2

A silicone hydrogel composition is formed by mixing tetraethoxysilane, 3-(trimethoxysilyl) propyl methacrylate, 2-hydroxyethyl methacrylate, [2-(methacryloyloxy) ethyl] dimethyl-(3-carboxypropyl) ammonium hydroxide, ethylene glycol dimethacrylate, and Irgacure-1173. Tetraethoxysilane has a mass percentage of 5.42% of a total mass of the silicone hydrogel composition. 3-(trimethoxysilyl) propyl methacrylate has a mass percentage of 2.62% of a total mass of the silicone hydrogel composition. 2-hydroxyethyl methacrylate has a mass percentage of 65.8% of a total mass of the silicone hydrogel composition. [2-(methacryloyloxy) ethyl] dimethyl-(3-carboxypropyl) ammonium hydroxide has a mass percentage of 24.02% of a total mass of the silicone hydrogel composition. Ethylene glycol dimethacrylate has a mass percentage of 1.31% of a total mass of the silicone hydrogel composition. Irgacure-1173 has a mass percentage of 0.83% of a total mass of the silicone hydrogel composition. The silicone hydrogel composition is fed into a mold and is exposed to ultraviolet radiation for 12 min, thereby forming an ophthalmic lens. The ophthalmic lens has a transparency of about 93%, a water-carrying capacity of about 48%, and an oxygen permeability coefficient of about 80.

### EXAMPLE 3

A silicone hydrogel composition is formed by mixing tetraethoxysilane, 3-(trimethoxysilyl) propyl methacrylate, 2-hydroxyethyl methacrylate, [2-(methacryloyloxy) ethyl] dimethyl-(3-carboxypropyl) ammonium hydroxide, ethylene glycol dimethacrylate, and Irgacure-1173. Tetraethoxysilane has a mass percentage of 16.2% of a total mass of the silicone hydrogel composition. 3-(trimethoxysilyl) propyl methacrylate has a mass percentage of 1.58% of a total mass of the silicone hydrogel composition. 2-hydroxyethyl methacrylate has a mass percentage of 35.8% of a total mass of the silicone hydrogel composition. [2-(methacryloyloxy) ethyl] dimethyl-(3-carboxypropyl) ammonium hydroxide has a mass percentage of 44.39% of a total mass of the silicone hydrogel composition. Ethylene glycol dimethacrylate has a mass percentage of 1.08% of a total mass of the silicone hydrogel composition. Irgacure-1173 has a mass percentage of 0.95% of a total mass of the silicone hydrogel composition. The silicone hydrogel composition is fed into a mold and is exposed to ultraviolet radiation for 12 min, thereby forming an ophthalmic lens. The ophthalmic lens has a transparency of about 94%, a water-carrying capacity of about 52%, and an oxygen permeability coefficient of about 100.

### EXAMPLE 4

A silicone hydrogel composition is formed by mixing tetraethoxysilane, 3-(trimethoxysilyl) propyl methacrylate, 2-hydroxyethyl methacrylate, [2-(methacryloyloxy) ethyl] dimethyl-(3-carboxypropyl) ammonium hydroxide, ethylene glycol dimethacrylate, and Irgacure-1173. Tetraethoxysilane has a mass percentage of 20.6% of a total mass of the silicone hydrogel composition. 3-(trimethoxysilyl) propyl methacrylate has a mass percentage of 0.86% of a total mass of the silicone hydrogel composition. 2-hydroxyethyl methacrylate has a mass percentage of 36.3% of a total mass of the silicone hydrogel composition. [2-(methacryloyloxy) ethyl] dimethyl-(3-carboxypropyl) ammonium hydroxide has a mass percentage of 39.93% of a total mass of the silicone hydrogel composition. Ethylene glycol dimethacrylate has a mass percentage of 1.03% of a total mass of the silicone hydrogel composition. Irgacure-1173 has a mass percentage of 0.98% of a total mass of the silicone hydrogel composition. The silicone hydrogel composition is fed into a mold and is exposed to ultraviolet radiation for 12 min, thereby forming an ophthalmic lens. The ophthalmic lens has a transparency of about 92%, a water-carrying capacity of about 45%, and an oxygen permeability coefficient of about 120.

### EXAMPLE 5

A silicone hydrogel composition is formed by mixing tetraethoxysilane, 3-(trimethoxysilyl) propyl methacrylate, 2-hydroxyethyl methacrylate, [2-(methacryloyloxy) ethyl] dimethyl-(3-sulfopropyl) ammonium hydroxide, ethylene glycol dimethacrylate, and Irgacure-1173. Tetraethoxysilane has a mass percentage of 15.7% of a total mass of the silicone hydrogel composition. 3-(trimethoxysilyl) propyl methacrylate has a mass percentage of 1.62% of a total mass of the silicone hydrogel composition. 2-hydroxyethyl methacrylate has a mass percentage of 33.2% of a total mass of the silicone hydrogel composition. [2-(methacryloyloxy) ethyl] dimethyl-(3-sulfopropyl) ammonium hydroxide has a mass percentage of 47.31% of a total mass of the silicone hydrogel composition. Ethylene glycol dimethacrylate has a mass percentage of 1.12% of a total mass of the silicone hydrogel composition. Irgacure-1173 has a mass percentage of 1.05% of a total mass of the silicone hydrogel composition. The silicone hydrogel composition is fed into a mold and is exposed to ultraviolet radiation for 12 min, thereby forming an ophthalmic lens. The ophthalmic lens has a transparency of about 93%, a water-carrying capacity of about 68%, and an oxygen permeability coefficient of about 100.

### EXAMPLE 6

A silicone hydrogel composition is formed by mixing tetraethoxysilane, 3-(trimethoxysilyl) propyl methacrylate, 2-hydroxyethyl methacrylate, 2-methacryloyloxyethyl phosphorylcholine, ethylene glycol dimethacrylate, and Irgacure-1173. Tetraethoxysilane has a mass percentage of 20.1% of a total mass of the silicone hydrogel composition. 3-(trimethoxysilyl) propyl methacrylate has a mass percentage of 0.89% of a total mass of the silicone hydrogel composition. 2-hydroxyethyl methacrylate has a mass percentage of 37.2% of a total mass of the silicone hydrogel composition. 2-methacryloyloxyethyl phosphorylcholine has a mass percentage of 40.6% of a total mass of the silicone hydrogel composition. Ethylene glycol dimethacrylate has a mass percentage of 0.83% of a total mass of the silicone hydrogel composition. Irgacure-1173 has a mass percentage of 0.38% of a total mass of the silicone hydrogel composition. The silicone hydrogel composition is fed into a mold and is exposed to ultraviolet radiation for 12 min, thereby forming an ophthalmic lens. The ophthalmic lens has a transparency of about 92%, a water-carrying capacity of about 45%, and an oxygen permeability coefficient of about 120.

### EXAMPLE 7

A silicone hydrogel composition is formed by mixing tetraethoxysilane, 3-(trimethoxysilyl) propyl methacrylate, 2-hydroxyethyl methacrylate, [3-(methacryloylamino) propyl] dimethyl(3-sulfopropyl) ammonium hydroxide inner salt, ethylene glycol dimethacrylate, and Irgacure-1173. Tetraethoxysilane has a mass percentage of 13.7% of a total mass of the silicone hydrogel composition. 3-(trimethoxysilyl) propyl methacrylate has a mass percentage of 1.3% of a total mass of the silicone hydrogel composition. 2-hydroxyethyl methacrylate has a mass percentage of 52% of a total mass of the silicone hydrogel composition. [3-(methacryloylamino) propyl] dimethyl(3-sulfopropyl) ammonium hydroxide inner salt has a mass percentage of 32% of a total mass of the silicone hydrogel composition. Ethylene glycol dimethacrylate has a mass percentage of 0.3% of a total mass of the silicone hydrogel composition. Irgacure-1173 has a mass percentage of 0.7% of a total mass of the silicone hydrogel composition. The silicone hydrogel composition is fed into a mold and is exposed to ultraviolet radiation for 10 min, thereby forming an ophthalmic lens. The ophthalmic lens has a transparency of about 99%, a water-carrying capacity of about 52%, and an oxygen permeability coefficient of about 115.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A silicone hydrogel composition comprising:
tetraethoxysilane;
3-(trimethoxysilyl) propyl methacrylate;
2-hydroxyethyl methacrylate;
a zwitterionic compound;
a cross-linking agent; and
an initiator.

2. The silicone hydrogel composition of claim 1, wherein tetraethoxysilane has a mass percentage of about 1% to about 25% of a total mass of the silicone hydrogel composition, 3-(trimethoxysilyl) propyl methacrylate has a mass percentage of about 0.5% to about 12% of a total mass of the silicone hydrogel composition, 2-hydroxyethyl methacrylate has a mass percentage of about 0 to about 76% of a total mass of the silicone hydrogel composition, the zwitterionic compound has a mass percentage of about 18% to about 97% of a total mass of the silicone hydrogel composition, the cross-linking agent has a mass percentage of about 0.32% to about 6.5% of a total mass of the silicone hydrogel composition, the initiator has a mass percentage of about 0.23% to about 5.8% of a total mass of the silicone hydrogel composition.

3. The silicone hydrogel composition of claim 1, wherein the zwitterionic compound is selected from a group consisting of a sulfobetaine zwitterionic compound, a carboxybetaine zwitterionic compound, a phosphorylcholine zwitterionic compound, and any combination thereof, the sulfobetaine zwitterionic compound has a chemical structural formula of 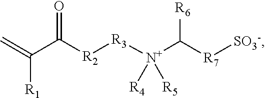
the carboxybetaine zwitterionic compound has a chemical structural formula of 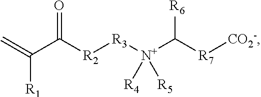
the phosphorylcholine zwitterionic compound has a chemical structural formula of 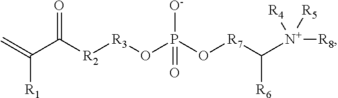
R₁ and R₆ each represents at least one of hydrogen group and methyl group, R₂ represents at least one of oxygen group and imino group, R₂ represents at least one of straight-chain alkane group, branched alkane group, 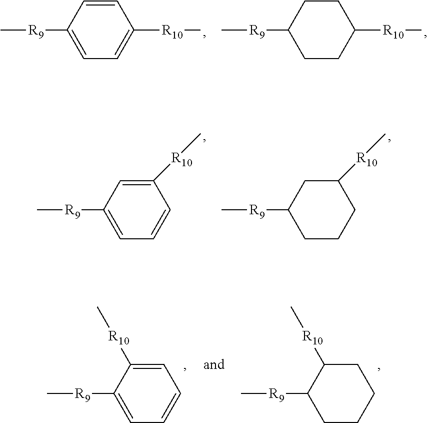
R₉ and R₁₀ each represents at least one of at least one of straight-chain alkane group and branched alkane group, R₄ and R₅ each represents at least one of methyl group, ethyl group, and propyl group, R₇ and R₈ each represents at least one of straight-chain alkane group and branched alkane group.

4. The silicone hydrogel composition of claim 3, wherein the zwitterionic compound is selected from a group consisting of [2-(methacryloyloxy) ethyl] dimethyl-(3-sulfopropyl) ammonium hydroxide having a chemical structural formula of 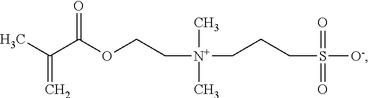
[3-(methacryloylamino) propyl] dimethyl(3-sulfopropyl) ammonium hydroxide inner salt having a chemical structural formula of 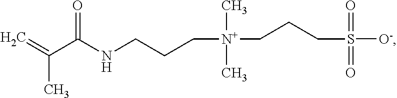
2-methacryloyloxyethyl phosphorylcholine having a chemical structural formula of 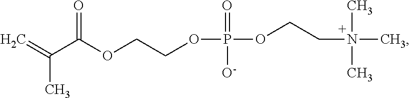
[2-(methacryloyloxy) ethyl] dimethyl-(3-carboxypropyl) ammonium hydroxide having a chemical structural formula of 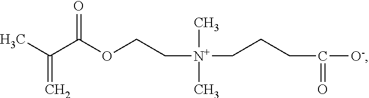
and any combination thereof.

5. A method for manufacturing an ophthalmic lens comprising:
providing a silicone hydrogel composition comprising tetraethoxysilane, 3-(trimethoxysilyl) propyl methacrylate, 2-hydroxyethyl methacrylate, a zwitterionic compound, a cross-linking agent, and an initiator; and
feeding the silicone hydrogel composition into a mold, and exposing the silicone hydrogel composition to ultraviolet radiation or heated, to cause tetraethoxysilane, 3-(trimethoxysilyl) propyl methacrylate, 2-hydroxyethyl methacrylate, the zwitterionic compound, the cross-linking agent, and the initiator in the silicone hydrogel composition to undergoing polymerization reaction, thereby forming the ophthalmic lens.

6. The method of claim 5, wherein the tetraethoxysilane has a mass percentage of about 1% to about 25% of a total mass of the silicone hydrogel composition, 3-(trimethoxysilyl) propyl methacrylate has a mass percentage of about 0.5% to about 12% of a total mass of the silicone hydrogel composition, 2-hydroxyethyl methacrylate has a mass percentage of about 0 to about 76% of a total mass of the silicone hydrogel composition, the zwitterionic compound has a mass percentage of about 18% to about 97% of a total mass of the silicone hydrogel composition, the cross-linking agent has a mass percentage of about 0.32% to about 6.5% of a total mass of the silicone hydrogel composition, the initiator has a mass percentage of about 0.23% to about 5.8% of a total mass of the silicone hydrogel composition.

7. The method of claim 5, wherein the zwitterionic compound is selected from a group consisting of a sulfobetaine zwitterionic compound, a carboxybetaine zwitterionic compound, a phosphorylcholine zwitterionic compound, and any combination thereof, the sulfobetaine zwitterionic compound has a chemical structural formula of 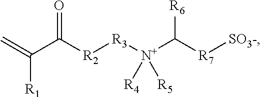
the carboxybetaine zwitterionic compound has a chemical structural formula of 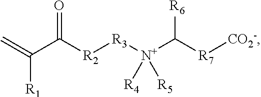
the phosphorylcholine zwitterionic compound has a chemical structural formula of 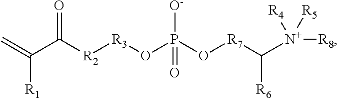
R₁ and R₆ each represents at least one of hydrogen group and methyl group, R₂ represents at least one of oxygen group and imino group, R₂ represents at least one of straight-chain alkane group, branched alkane group, 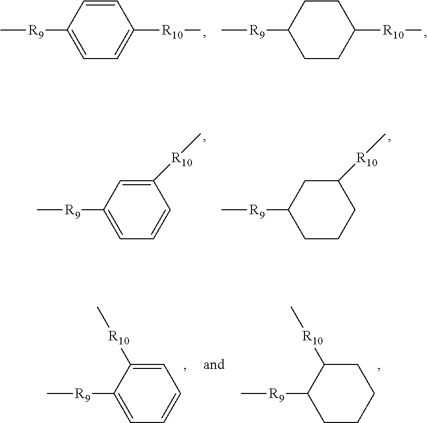
R₉ and R₁₀ each represents at least one of at least one of straight-chain alkane group and branched alkane group, R₄ and R₅ each represents at least one of methyl group, ethyl group, and propyl group, R₇ and R₈ each represents at least one of straight-chain alkane group and branched alkane group.

8. The method of claim 7, wherein the zwitterionic compound is selected from a group consisting of [2-(methacryloyloxy) ethyl] dimethyl-(3-sulfopropyl) ammonium hydroxide having a chemical structural formula of 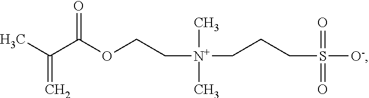
[3-(methacryloylamino) propyl] dimethyl(3-sulfopropyl) ammonium hydroxide inner salt having a chemical structural formula of 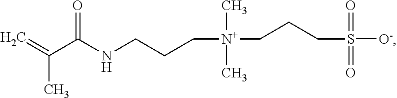
2-methacryloyloxyethyl phosphorylcholine having a chemical structural formula of 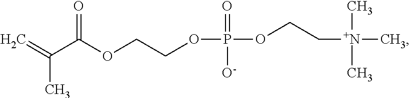 [SMILES: C=C(C)C(=O)OCCOP(=O)([O-])OCC[N+](C)(C)C]
[2-(methacryloyloxy) ethyl] dimethyl-(3-carboxypropyl) ammonium hydroxide having a chemical structural formula of 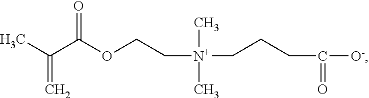
and any combination thereof.

9. The method of claim 5, wherein the mixture is exposed to ultraviolet radiation for about 5 min to about 30 min, the mixture is heated at about 65 degrees Celsius to about 90 degrees Celsius for about 45 min to about 6 h.

10. An ophthalmic lens comprising 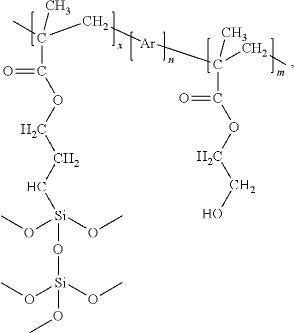
wherein 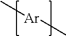
is selected from at least one of 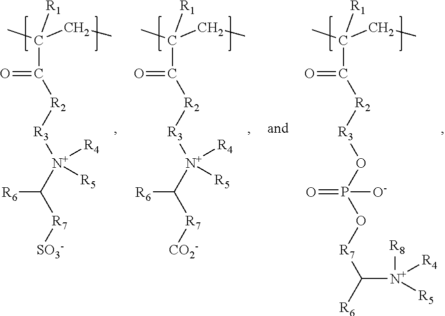
R₁ and R₆ each represents at least one of hydrogen group and methyl group, R₂ represents at least one of oxygen group and imino group, R₂ represents at least one of straight-chain alkane group, branched alkane group, 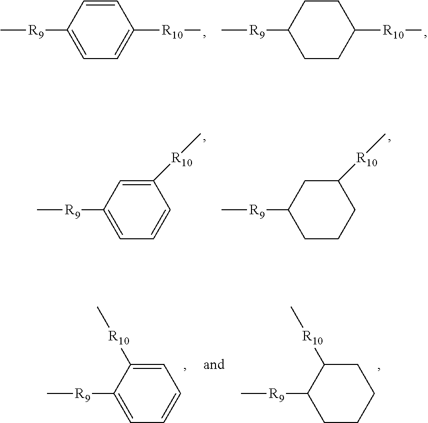
R₉ and R₁₀ each represents at least one of at least one of straight-chain alkane group and branched alkane group, R₄ and R₅ each represents at least one of methyl group, ethyl group, and propyl group, R₇ and R₈ each represents at least one of straight-chain alkane group and branched alkane group.

11. The ophthalmic lens of claim 10, wherein 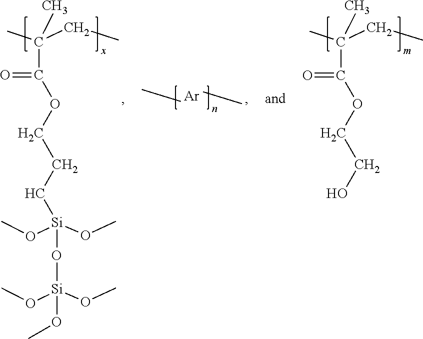
are alternatively bonded in that sequence.

12. The ophthalmic lens of claim 10, wherein a degree of polymerization x is from about 5 to about 45, a degree of polymerization n is from about 8 to about 72, and a degree of polymerization m is from about 13 to about 86.
